(19) United States
(12) Patent Application Publication
(10) Pub. No.: US 2014/0334093 A1
(43) Pub. Date: Nov. 13, 2014

(54) ELECTRONIC DEVICE WITH AIR DUCT

(71) Applicants: HON HAI PRECISION INDUSTRY CO., LTD., New Taipei (TW); HONG FU JIN PERCISION INDUSTRY (ShenZhen) CO., LTD ., Shenzhen (CN)

(72) Inventors: CHAO-KE WEI, New Taipei (TW); ZI-XUAN ZHANG, Shenzhen (CN)

(73) Assignees: HON HAI PRECISION INDUSTRY CO., LTD., New Taipei (TW); HONG FU JIN PERCISION INDUSTRY (ShenZhen) CO., LTD, Shenzhen (CN)

(21) Appl. No.: 14/144,398

(22) Filed: Dec. 30, 2013

(30) Foreign Application Priority Data
May 10, 2013 (CN) 2013101695200

(51) Int. Cl. G06F 1/20

(52) U.S. Cl. CPC G06F 1/20
USPC 361/679.47; 138/46

(57) ABSTRACT

An electronic device includes a motherboard. A first heat sink and a second heat sink are set on the motherboard. A number of memories are set on the motherboard and located at two sides of the first heat sink. An air duct is located between the first heat sink and the second heat sink. The air duct includes a main body and two air baffles. The main body includes a top board and two side boards extending from opposite sides of the top board. The top board and the two side boards cooperatively define an airflow channel. The airflow channel includes an air intake facing the first heat sink, and an air outlet facing the second heat sink. Each side board defines an opening. Each air baffle is pivotably mounted to the corresponding side board and adjacent to the corresponding opening.

### BACKGROUND

1. Technical Field

The disclosure relates to electronic devices and, particularly, to an electronic device comprising an air duct for guiding airflow.

2. Description of Related Art

In a server system with multiple central processing units (CPUs), the CPUs may be placed in an airflow channel, so that the CPUs in a rear portion of the server system are easily preheated by heat from the CPUs in a front portion of the server system. However, the CPUs of the sever system may be blocked by additional components of the server system, such as memories, which results in inefficient heat-dissipation of the CPUs in the rear portion.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric, assembled view of an embodiment of an electronic device, wherein the electronic device comprises an air duct.

FIG. 2 is an isometric, exploded view of FIG. 1.

FIG. 3 is an isometric, exploded view of the air duct of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one”.

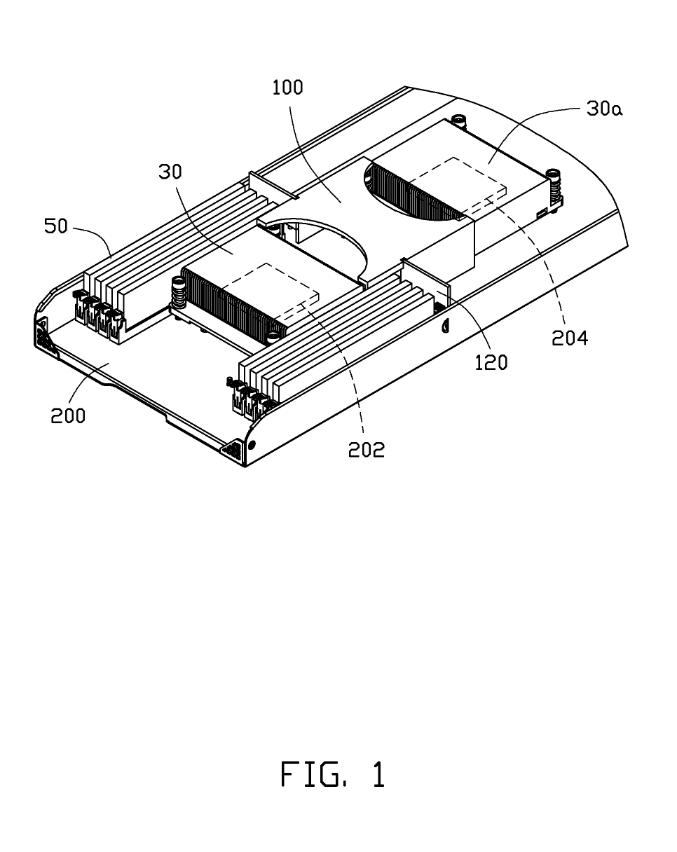

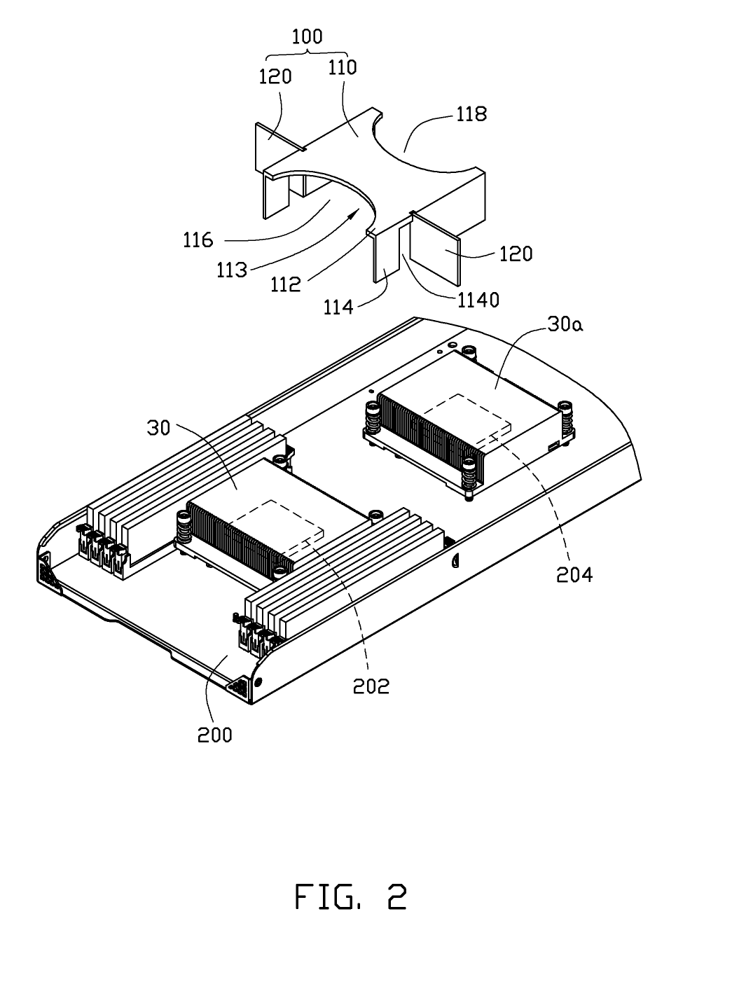

FIGS. 1 and 2 show an embodiment of an electronic device, which comprises a motherboard 200, first and second heat-generation elements 202 and 204 mounted on the motherboard 200, an air duct 100 located on the motherboard 200 and between the first heat-generation element 202 and the second heat-generation element 204, a first heat sink 30 attached on the first heat-generation element 202, a second heat sink 30a attached on the second heat-generation element 204, and a plurality of memories 50. The memories 50 are mounted on the motherboard 200 and located at two opposite sides of the first heat sink 30. In one embodiment, a fan (not shown) is set adjacent to a side of the first heat sink 30 away from the second heat sink 30a, and airflow generated by the fan flows through the first heat sink 30 and the memories 50 toward the second heat sink 30a.

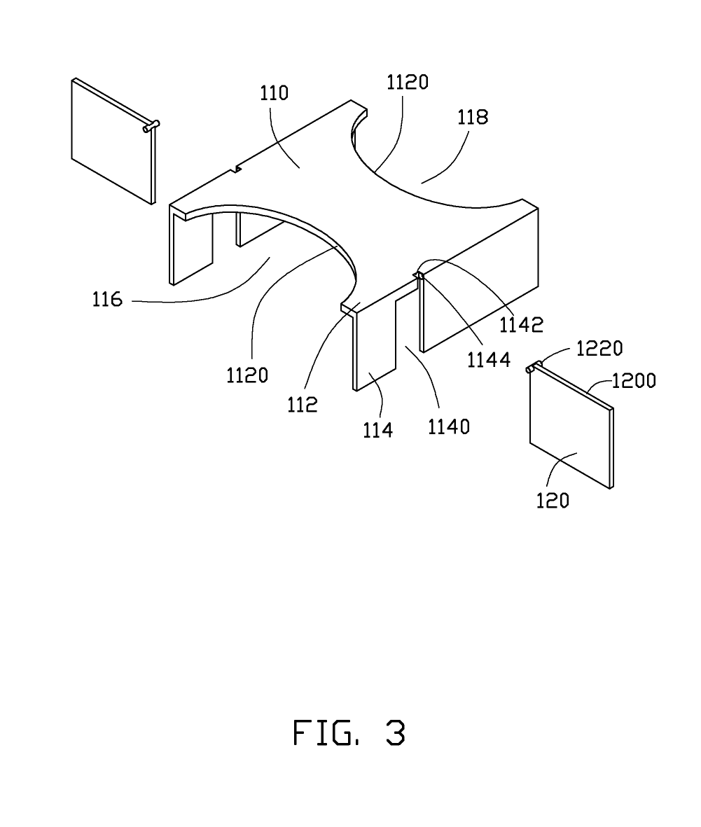

Referring to FIG. 3, the air duct 100 comprises a main body 110 and two air baffles 120. The air baffles 120 are pivotably mounted to respective opposite sides of the main body 110. The main body 110 comprises a top board 112, and two side boards 114 extending down from the respective opposite sides of the top board 112. The top board 12 and the two side boards 114 cooperatively bound an airflow channel 113. The air channel 113 is divided into an air intake 116 at a front end of the main body 110, and an air outlet 118 at a rear end of the main body 110. The air intake 116 and the air outlet 118 communicate with the airflow channel 113.

Each of the front and back ends of the top board 112 defines an arc-shaped cutout 1120, thereby making a middle portion of the top board 112 between the cutouts 1120 easy to be grasped. Each side board 114 defines an opening 1140 communicating with the air intake 116. The top board 112 defines two slots 1442, each of which communicates with a corresponding opening 1140. Front and rear sidewalls bounding each slot 1142 define pivot holes 1144 in alignment with each other. The slots 1442 are defined at a side of the openings 1140 away from the air intake 116.

Each air baffle 120 comprises a substantially rectangular sheet 1200 and two pivots 1220. The two pivots 1220 extend substantially perpendicularly from respective opposite surfaces of a top corner portion of the sheet 1200.

In assembly, the pivots 1220 are pivotably received in the corresponding pivot holes 1144, so that the air baffles 120 are pivotably mounted to the sides of the main body 110. The air duct 100 is placed on the motherboard 200 between the first and second heat sinks 30 and 30a, such that the air intake 116 faces the first heat sink 30, and the air outlet 118 faces the second heat sink 30a. The air baffles 120 are located adjacent to ends of the memories 50 adjacent to the second heat sink 30a.

The air baffles 120 of the air duct 100 can guide airflow flowing through the memories 50 to enter the airflow channel 113 through the openings 1140, thereby dissipating heat for the second heat sink 30a. In addition, the air baffles 120 can be pivoted up to facilitate removing or mounting of the memories 50 easily.

It is to be understood, however, that even though numerous characteristics and advantages of certain embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An air duct, comprising:
a main body comprising a top board and two side boards extending down from opposite sides of the top board, wherein the top board and the two side boards cooperatively bound an airflow channel, the airflow channel comprises an air intake defined in a front end of the airflow channel and an air outlet defined in a rear end of the airflow channel, one of the side boards defines an opening adjacent to the air intake; and
an air baffle pivotably mounted to the main body, at the opening of the side board.

2. The air duct of claim 1, wherein the top board defines two arc-shaped cutouts, respectively adjacent to the air intake and the air outlet.

3. The air duct of claim 1, wherein the top board defines a slot adjacent to one of the openings, and rear and front sidewalls bounding the slot define two pivot holes, the air baffle comprises a sheet and two pivots extended from opposite sides of the sheet, the pivots are pivotably received in the corresponding pivot holes.

4. An electronic device, comprising:
a motherboard;
first and second heat-generation elements mounted on the motherboard;
a first heat sink attached on the first heat-generation element;
a second heat sink attached on the second heat-generation element;
a plurality of memories mounted on the motherboard and located at two opposite sides of the first heat sink; and
an air duct located on the motherboard and between the first heat sink and the second heat sink, and comprising a main body and two air baffles, wherein the main body comprises a top board and two side boards extending down from opposite sides of the top board, wherein the top board and the two side boards cooperatively bound an airflow channel, the airflow channel comprises an air intake facing the first heat sink and an air outlet facing the second heat sink, the side boards define two openings adjacent to the air intake, the air baffles are pivotably mounted to the main body, and a side of the openings opposite to the air intake.

5. The electronic device of claim 4, wherein the top board defines two arc-shaped cutouts, respectively adjacent to the air intake and the air outlet.

6. The electronic device of claim 4, wherein the top board defines two slots adjacent to the corresponding openings, and rear and front sidewalls bounding each slot define two pivot holes, each air baffle comprises a sheet and two pivots perpendicularly extended from opposite sides of the sheet, the pivots are pivotably received in the corresponding pivot holes.
